(19) United States
(12) Patent Application Publication
(10) Pub. No.: US 2021/0302571 A1
(43) Pub. Date: Sep. 30, 2021

(54) OBJECT DETECTION SYSTEM

(71) Applicant: ASIN SEIKI KABUSHIKI KAISHA, Kariya-shi (JP)

(72) Inventors: Koichi SASSA, Kariya-shi (JP); Ippei SUGAE, Kariya-shi (JP)

(73) Assignee: ASIN SEIKI KABUSHIKI KAISHA, Kariya-shi (JP)

(21) Appl. No.: 17/197,209

(22) Filed: Mar. 10, 2021

(30) Foreign Application Priority Data
Mar. 30, 2020 (JP) 2020-061269

(51) Int. Cl. G01S 15/04; G01S 15/931; G01S 15/08; B60W 30/18

(52) U.S. Cl. CPC G01S 15/04; G01S 15/931; G01S 2015/938; B60W 30/18009; G01S 15/08

(57) ABSTRACT

An object detection system includes: a transmission unit transmitting a transmission wave; a reception unit receiving a reception wave which is the transmission wave reflected and returned by an object; a signal processing unit configured to sample a processing target signal corresponding to the reception wave and acquire a difference signal based on a difference between the processing target signal for at least one sample and an average of values of the processing target signals for samples; a detection processing unit detecting, based on a value of the difference signal, a distance to the object a plurality of times with a lapse of time; and an identification processing unit identifying the object based on a transition, with the lapse of time, between the distance to the object and the value of the processing target signal at the detection timing at which the distance to the object is detected.

### CROSS REFERENCE TO RELATED APPLICATIONS

This application is based on and claims priority under 35 U.S.C. §119 to Japanese Patent Application 2020-061269, filed on Mar. 30, 2020, the entire content of which is incorporated herein by reference.

### TECHNICAL FIELD

This disclosure relates to an object detection system.

### BACKGROUND DISCUSSION

In the related art, there has been known constant false alarm rate (CFAR) processing as processing for reducing noise called clutter generated due to reflection by an object that is not to be detected when a distance to an object is detected based on transmission and reception of a wave using a radar. The CFAR processing is, roughly speaking, processing of acquiring a difference signal based on a difference between a value (signal level) of a processing target signal corresponding to a reception wave and an average value of values of the processing target signals. In the CFAR processing, a reception wave which is a transmission wave reflected and returned by an object to be detected is accurately detected based on a value of the difference signal, and as a result, a distance to the object is accurately detected.

An example of the related art includes JP 2006-292597A (Reference 1).

Here, a detection result of a distance to an object can be used for, for example, various kinds of control such as control of a traveling state of a vehicle. In this case, if the detection result of a distance to an object and an identification result of what kind of object the object is can be obtained, various kinds of control can be executed more effectively, which is beneficial.

A need thus exists for an object detection system which is not susceptible to the drawback mentioned above.

### SUMMARY

An object detection system as an example of the present disclosure includes: a transmission unit configured to transmit a transmission wave; a reception unit configured to receive a reception wave which is the transmission wave reflected and returned by an object; a signal processing unit configured to sample a processing target signal corresponding to the reception wave and acquire a difference signal based on a difference between a value of the processing target signal for at least one sample corresponding to a reception wave received at a certain detection timing and an average value of values of the processing target signals for a plurality of samples corresponding to a reception wave received in at least one of a first period and a second period respectively existing before and after the detection timing and having a predetermined time length; a detection processing unit configured to detect, based on a value of the difference signal, a distance to the object at the detection timing a plurality of times with a lapse of time; and an identification processing unit configured to identify the object based on a transition, with the lapse of time, between the distance to the object and the value of the processing target signal at the detection timing at which the distance to the object is detected.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary and schematic view showing an appearance of a vehicle including an object detection system according to an embodiment as viewed from above;

FIG. 2 is an exemplary and schematic block diagram showing a schematic hardware configuration of an electronic control unit (ECU) and a distance detection device of the object detection system according to the embodiment;

FIG. 3 is an exemplary and schematic diagram for illustrating an outline of a technique to be used by the distance detection device according to the embodiment to detect a distance to an object;

FIG. 4 is an exemplary and schematic block diagram showing a detailed configuration of the distance detection device according to the embodiment;

FIG. 5 is an exemplary and schematic diagram for illustrating an example of constant false alarm rate (CFAR) processing that can be executed in the embodiment;

FIG. 6 is an exemplary and schematic diagram showing an example of waveforms of signals before and after the CFAR processing according to the embodiment;

FIG. 7 is an exemplary and schematic block diagram showing a function of the ECU according to the embodiment;

FIG. 8 is an exemplary and schematic diagram showing a situation in which a height of an object to be detected is high in the embodiment;

FIG. 9 is an exemplary and schematic diagram showing a situation in which a height of an object to be detected is low in the embodiment;

FIG. 10 is an exemplary and schematic diagram showing an example of a threshold value to be used to identify an object according to the embodiment;

FIG. 11 is an exemplary and schematic flowchart showing a process to be performed by the object detection system according to the embodiment; and

FIG. 12 is an exemplary and schematic diagram for illustrating identification of an object according to a modification.

### DETAILED DESCRIPTION

Hereinafter, embodiments and modifications disclosed here will be described with reference to the drawings. Configurations of the embodiments and the modifications to be described below and actions and effects obtained by the configurations are merely examples, and are not limited to the following description.

### Embodiment

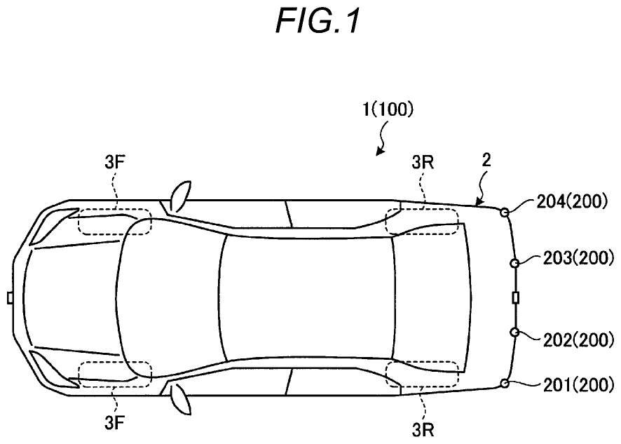

FIG. 1 is an exemplary and schematic view showing an appearance of a vehicle 1 including an object detection system according to an embodiment as viewed from above.

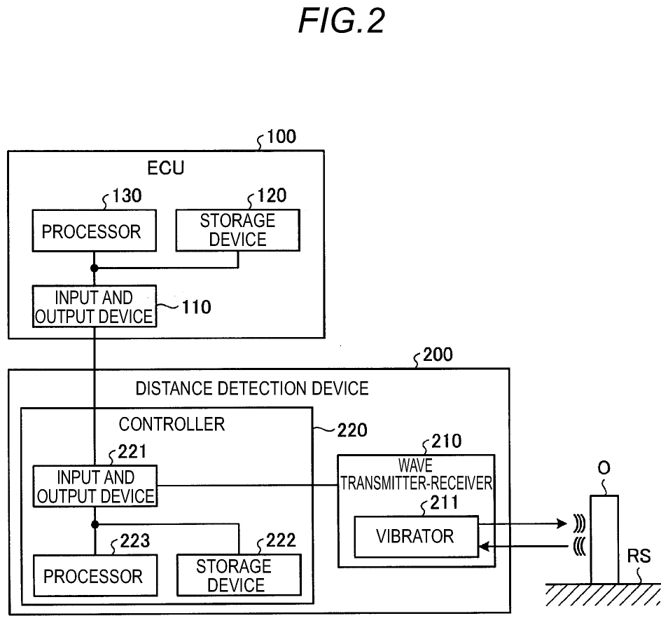

As to be described below, the object detection system according to the embodiment is an in-vehicle sensor system that detects information related to an object (for example, an obstacle O shown in FIG. 2 to be described later) including a person existing in surroundings by performing transmission and reception of a sound wave (ultrasonic wave) and acquiring a time difference between the transmission and the reception, and the like.

More specifically, as shown in FIG. 1, the object detection system according to the embodiment includes an electronic control unit (ECU) 100 as an in-vehicle control device and distance detection devices 201 to 204 as in-vehicle sonars. The ECU 100 is mounted inside a four-wheel vehicle 1 including a pair of front wheels 3F and a pair of rear wheels 3R, and the distance detection devices 201 to 204 are mounted on an exterior of the vehicle 1.

In an example shown in FIG. 1, as an example, the distance detection devices 201 to 204 are installed at different positions in a rear end portion (rear bumper) of a vehicle body 2 as the exterior of the vehicle 1, but installation positions of the distance detection devices 201 to 204 are not limited to the example shown in FIG. 1. For example, the distance detection devices 201 to 204 may be installed at a front end portion (front bumper) of the vehicle body 2, may be installed at a side surface portion of the vehicle body 2, or may be installed at two or more of the rear end portion, the front end portion, and the side surface portion.

In the embodiment, hardware configurations and functions of the distance detection devices 201 to 204 are the same as one another. Therefore, in the following description, the distance detection devices 201 to 204 may be collectively referred to as a distance detection device 200 for the sake of simplicity. In the embodiment, the number of distance detection devices 200 is not limited to four as shown in FIG. 1.

FIG. 2 is an exemplary and schematic block diagram showing a schematic hardware configuration of the ECU 100 and the distance detection device 200 according to the embodiment.

As shown in FIG. 2, the ECU 100 includes a hardware configuration similar to that of a normal computer. More specifically, the ECU 100 includes an input and output device 110, a storage device 120, and a processor 130.

The input and output device 110 is an interface for implementing transmission and reception of information between the ECU 100 and an outside (the distance detection device 200 in the example shown in FIG. 1).

The storage device 120 includes a main storage device such as a read only memory (ROM) or a random access memory (RAM), and/or an auxiliary storage device such as a hard disk drive (HDD) or a solid state drive (SSD).

The processor 130 controls various processes to be executed by the ECU 100. The processor 130 includes, for example, an arithmetic device such as a central processing unit (CPU). The processor 130 implements, for example, various functions such as automatic parking by reading and executing a computer program stored in the storage device 120.

On the other hand, as shown in FIG. 2, the distance detection device 200 includes a wave transmitter-receiver 210 and a controller 220. The wave transmitter-receiver 210 is an example of a “transmission and reception unit”.

The wave transmitter-receiver 210 includes a vibrator 211 configured with a piezoelectric element or the like, and the vibrator 211 transmits and receives an ultrasonic wave.

More specifically, the wave transmitter-receiver 210 transmits, as a transmission wave, an ultrasonic wave generated in response to vibration of the vibrator 211, and receives, as a reception wave, vibration of the vibrator 211 caused by the ultrasonic wave transmitted as the transmission wave being reflected and returned by an object existing outside. In an example shown in FIG. 2, the obstacle 0 installed on a road surface RS is shown as an object that reflects the ultrasonic wave from the wave transmitter-receiver 210.

In the example shown in FIG. 2, a configuration is shown in which both transmission of a transmission wave and reception of a reception wave are implemented by the single wave transmitter-receiver 210 including the single vibrator 211. However, a technique of the embodiment is also applicable to, for example, a configuration in which a configuration on a transmission side and a configuration on a reception side are separated, such as a configuration in which a first vibrator for transmitting a transmission wave and a second vibrator for receiving a reception wave are separately provided.

The controller 220 includes a hardware configuration similar to that of a normal computer. More specifically, the controller 220 includes an input and output device 221, a storage device 222, and a processor 223.

The input and output device 221 is an interface for implementing transmission and reception of information between the controller 220 and an outside (the ECU 100 and the wave transmitter-receiver 210 in the example shown in FIG. 2).

The storage device 222 includes a main storage device such as a ROM and a RAM, and an auxiliary storage device such as an HDD or an SSD.

The processor 223 controls various processes to be executed in the controller 220. The processor 223 includes, for example, an arithmetic device such as a CPU. The processor 223 implements various functions by reading and executing a computer program stored in the storage device 222.

Here, the distance detection device 200 according to the embodiment detects a distance to an object by a technique called a so-called time of flight (TOF) method. As to be described in detail below, the TOF method is a technique of calculating a distance to an object in consideration of a difference between a timing at which a transmission wave is transmitted (more specifically, transmission is started) and a timing at which a reception wave is received (more specifically, reception is started).

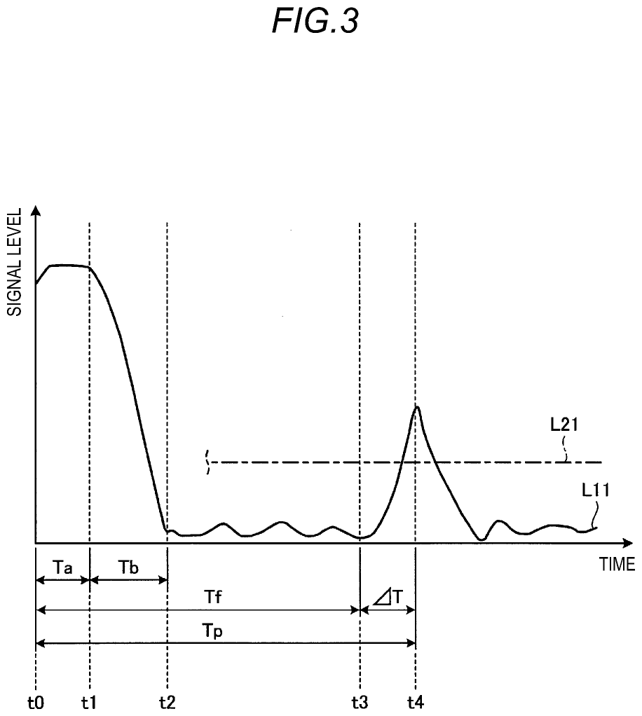

FIG. 3 is an exemplary and schematic diagram for illustrating an outline of the technique to be used by the distance detection device 200 according to the embodiment to detect a distance to an object.

More specifically, FIG. 3 is a diagram exemplarily and schematically showing, in a graph format, a time change of a signal level (for example, amplitude) of an ultrasonic wave transmitted and received by the distance detection device 200 according to the embodiment. In a graph shown in FIG. 3, a horizontal axis corresponds to a time, and a vertical axis corresponds to the signal level of a signal transmitted and received by the distance detection device 200 via the wave transmitter-receiver 210 (vibrator 211).

In the graph shown in FIG. 3, a solid line L11 represents an example of an envelope representing the time change of the signal level of a signal transmitted and received by the distance detection device 200, that is, a degree of vibration of the vibrator 211. It can be seen from the solid line L11 that the vibration of the vibrator 211 due to inertia continues while attenuating during a time Tb until a timing t2 after the transmission of the transmission wave is completed at a timing t1 by the vibrator 211 being driven and vibrated for a time Ta from a timing to. Therefore, in the graph shown in FIG. 3, the time Tb corresponds to a so-called reverberation time.

The solid line L11 reaches, at a timing t4 at which a time Tp elapses since the timing t0 at which the transmission of the transmission wave is started, a peak at which the degree of vibration of the vibrator 211 exceeds (or is equal to or greater than) a predetermined threshold value Th1 represented by an one-dot chain line L21. The threshold value Th1 is a value set in advance to identify whether the vibration of the vibrator 211 is caused by reception of a reception wave which is a transmission wave reflected and returned by an object to be detected (for example, the obstacle O shown in FIG. 2) or is caused by reception of a reception wave which is a transmission wave reflected and returned by an object not to be detected (for example, the road surface RS shown in FIG. 2).

Although FIG. 3 shows an example in which the threshold value Th1 is set as a constant value that does not change as the time elapses, in the embodiment, the threshold value Th1 may be set as a value that changes as the time elapses.

Here, vibration having a peak exceeding (or equal to or greater than) the threshold value Th1 can be regarded as being caused by the reception of the reception wave which is the transmission wave reflected and returned by the object to be detected. On the other hand, vibration having a peak equal to or less than (or less than) the threshold value Th1 can be regarded as being caused by the reception of the reception wave which is the transmission wave reflected and returned by the object not to be detected.

Therefore, it can be seen from the solid line L11 that the vibration of the vibrator 211 at the timing t4 is caused by the reception of the reception wave which is the transmission wave reflected and returned by the object to be detected.

In the solid line L11, the vibration of the vibrator 211 is attenuated after the timing t4. Therefore, the timing t4 corresponds to a timing at which the reception of the reception wave which is the transmission wave reflected and returned by the object to be detected is completed, in other words, a timing at which the transmission wave transmitted last at the timing t1 is returned as the reception wave.

In addition, in the solid line L11, a timing t3 as a start point of the peak at the timing t4 corresponds to a timing at which the reception of the reception wave which is the transmission wave reflected and returned by the object to be detected is started, in other words, a timing at which the transmission wave transmitted first at the timing t0 is returned as the reception wave. Therefore, in the solid line L11, a time ΔT between the timing t3 and the timing t4 is equal to the time Ta as a transmission time of the transmission wave.

Based on the above, in order to obtain the distance to an object to be detected by the TOF method, it is necessary to obtain a time Tf between the timing t0 at which the transmission wave starts to be transmitted and the timing t3 at which the reception wave starts to be received. The time Tf can be obtained by subtracting the time ΔT equal to the time Ta which is the transmission time of the transmission wave from the time Tp which is a difference between the timing t0 and the timing t4 at which the signal level of the reception wave reaches the peak exceeding the threshold value Th1.

The timing t0 at which the transmission wave starts to be transmitted can be easily specified as a timing at which the distance detection device 200 starts to operate, and the time Ta as the transmission time of the transmission wave is determined in advance by setting or the like. Therefore, in order to obtain the distance to an object to be detected by the TOF method, it is important to specify the timing t4 at which the signal level of the reception wave reaches the peak exceeding the threshold value Th1. Further, in order to specify the timing t4, it is important to accurately detect a correspondence relationship between the transmission wave and the reception wave which is the transmission wave reflected and returned by the object to be detected.

In the related art, there has been known constant false alarm rate (CFAR) processing as processing for reducing noise called clutter generated due to reflection by an object that is not to be detected when detecting a distance to an object based on transmission and reception of waves such as ultrasonic waves described above. The CFAR processing is, roughly speaking, processing of acquiring a difference signal based on a difference between a value (signal level) of a processing target signal corresponding to a reception wave and an average value of values of the processing target signals. In the CFAR processing, a reception wave which is a transmission wave reflected and returned by an object to be detected is accurately detected based on a value of the difference signal, and as a result, a distance to the object is accurately detected.

Here, a detection result of a distance to an object can be used for, for example, various kinds of control such as control of a traveling state of a vehicle. In this case, if the detection result of a distance to an object and an identification result of what kind of object the object is can be obtained, various kinds of control can be executed more effectively, which is beneficial.

Therefore, according to the embodiment, the detection result of the distance to an object and the identification result of the object are obtained based on a configuration as to be described below.

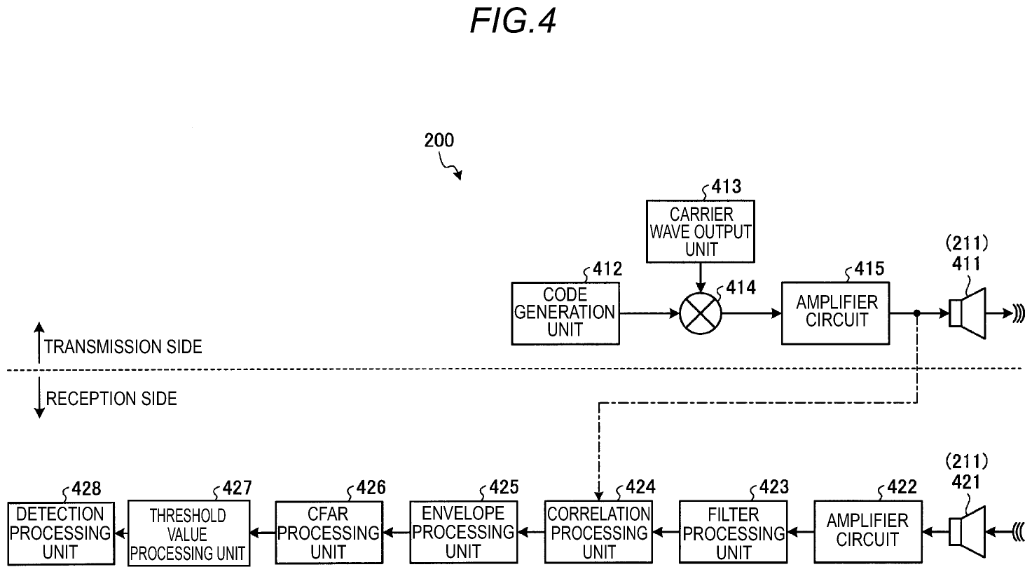

FIG. 4 is an exemplary and schematic block diagram showing a detailed configuration of the distance detection device 200 according to the embodiment.

In FIG. 4, a configuration on the transmission side and a configuration on the reception side are shown in a separated state, but such an aspect shown in FIG. 4 is merely for convenience of description. Therefore, in the embodiment, as described above, both the transmission of a transmission wave and the reception of a reception wave are implemented by the single wave transmitter-receiver 210. It is noted that, as described above, the technique of the embodiment is also applicable to a configuration in which the configuration on the transmission side and the configuration on the reception side are separated from each other.

In the embodiment, at least a part of the configuration shown in FIG. 4 is implemented as a result of cooperation between hardware and software, more specifically, as a result of the processor 223 of the distance detection device 200 reading and executing a computer program from the storage device 222. It is noted that, in the embodiment, at least a part of the configuration shown in FIG. 4 may be implemented by dedicated hardware (circuitry).

First, the configuration on the transmission side of the distance detection device 200 will be briefly described.

As shown in FIG. 4, the distance detection device 200 includes, as the configuration on the transmission side, a wave transmitter 411, a code generation unit 412, a carrier wave output unit 413, a multiplier 414, and an amplifier circuit 415. The wave transmitter 411 is an example of a “transmission unit”.

The wave transmitter 411 is configured with the vibrator 211 described above, and the vibrator 211 transmits a transmission wave corresponding to a transmission signal output (amplified) from the amplifier circuit 415.

Here, in the embodiment, based on the configuration to be described below, the wave transmitter 411 encodes the transmission wave so as to include identification information of a predetermined code length, and then transmits the encoded transmission wave.

The code generation unit 412 generates a pulse signal corresponding to a code of a bit string including consecutive 0 or 1 bit, for example. A length of the bit string corresponds to a code length of the identification information applied to the transmission signal. For example, the code length is set to such a length that transmission waves transmitted from the four distance detection devices 200 shown in FIG. 1 can be distinguished from each other.

The carrier wave output unit 413 outputs a carrier wave as a signal to which identification information is to be applied. For example, the carrier wave output unit 413 outputs a sine wave of a predetermined frequency as the carrier wave.

The multiplier 414 modulates the carrier wave so as to apply the identification information by multiplying an output from the code generation unit 412 and an output from the carrier wave output unit 413. Then, the multiplier 414 outputs the modulated carrier wave to which the identification information is applied to the amplifier circuit 415 as a transmission signal that is a source of the transmission wave. In the embodiment, as a modulation method, for example, a single modulation method ora combination of two or more modulation methods that are generally well known, such as an amplitude modulation method or a phase modulation method, may be used.

The amplifier circuit 415 amplifies the transmission signal output from the multiplier 414 and outputs the amplified transmission signal to the wave transmitter 411.

With such a configuration, in the embodiment, the code generation unit 412, the carrier wave output unit 413, the multiplier 414, and the amplifier circuit 415 transmit, by using the wave transmitter 411, the transmission wave to which predetermined identification information is applied.

Next, the configuration on the reception side of the distance detection device 200 will be briefly described.

As shown in FIG. 4, the distance detection device 200 includes, as the configuration on the reception side, a wave receiver 421, an amplifier circuit 422, a filter processing unit 423, a correlation processing unit 424, an envelope processing unit 425, a CFAR processing unit 426, a threshold value processing unit 427, and a detection processing unit 428. The wave receiver 421 is an example of a “reception unit”, and the CFAR processing unit 426 is an example of a “signal processing unit”.

The wave receiver 421 is configured with the vibrator 211 described above, and the vibrator 211 receives a transmission wave reflected by an object as a reception wave.

The amplifier circuit 422 amplifies a reception signal as a signal corresponding to the reception wave received by the wave receiver 421.

The filter processing unit 423 performs filtering processing on the reception signal, that is amplified by the amplifier circuit 422, to reduce noise. In the embodiment, the filter processing unit 423 may acquire information related to a frequency of the transmission signal and may further correct a frequency of the reception signal so as to match the frequency of the transmission signal.

The correlation processing unit 424 acquires a correlation value corresponding to a degree of similarity of the identification information between the transmission wave and the reception wave, based on, for example, the transmission signal acquired from the configuration on the transmission side and the reception signal filter-processed by the filter processing unit 423. The correlation value can be acquired based on a generally well-known correlation function or the like.

The envelope processing unit 425 obtains an envelope of a waveform of a correlation value signal as a signal based on the correlation value acquired by the correlation processing unit 424, and outputs the envelope as a processing target signal to the CFAR processing unit 426.

The CFAR processing unit 426 performs the CFAR processing on the processing target signal output from the envelope processing unit 425 to acquire a difference signal. As described above, the CFAR processing is, roughly speaking, processing of acquiring the difference signal based on a difference between a value (signal level) of the processing target signal and an average value of values of the processing target signals in order to reduce clutter included in the processing target signal.

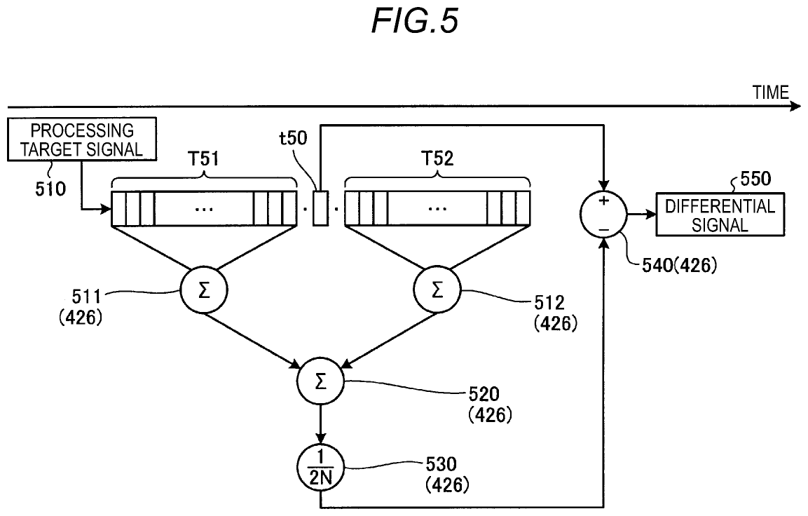

More specifically, the CFAR processing unit 426 according to the embodiment performs the CFAR processing in a form as shown in FIG. 5.

FIG. 5 is an exemplary and schematic diagram for illustrating an example of the CFAR processing that can be executed in the embodiment.

Hereinafter, cell averaging constant false alarm rate (CA-CFAR) processing will be described as an example of the CFAR processing.

As shown in FIG. 5, in the CA-CFAR processing, first, a processing target signal 510 is sampled at predetermined time intervals. Then, an arithmetic unit 511 of the CFAR processing unit 426 calculates a sum of the values of the processing target signals for N samples corresponding to the reception wave received in a first period T51 existing before a certain detection timing t50. In addition, an arithmetic unit 512 of the CFAR processing unit 426 calculates a sum of the values of the processing target signals for N samples corresponding to the reception wave received in a second period T52 existing after the detection timing t50.

Then, an arithmetic unit 520 of the CFAR processing unit 426 adds up calculation results of the arithmetic units 511 and 512. Then, an arithmetic unit 530 of the CFAR processing unit 426 divides the calculation result of the arithmetic unit 520 by 2N, which is a sum of the number N of samples of the processing target signal in the first period T51 and the number N of samples of the processing target signal in the second period T52, and calculates an average value of the values of the processing target signal in both first period T51 and second period T52.

Then, an arithmetic unit 540 of the CFAR processing unit 426 subtracts the average value as the calculation result of the arithmetic unit 530 from the value of the processing target signal at the detection timing t50 to obtain a difference signal 550.

As described above, the CFAR processing unit 416 according to the embodiment samples the processing target signal corresponding to the reception wave and acquire the difference signal based on the difference between the value of the processing target signal for (at least) one sample corresponding to the reception wave received at a certain detection timing and the average value of the values of the processing target signal for a plurality of samples corresponding to the reception wave received in at least one of a first period and a second period respectively existing before and after the detection timing and having a predetermined time length.

In the embodiment, as the CFAR processing, in addition to the CA-CFAR processing described above, a plurality of processings having different properties, such as a greatest of constant false alarm rate (GO-CFAR) processing and a smallest of constant false alarm rate (SO-CFAR) processing, may be considered. The CFAR processing unit 426 according to the embodiment may be configured to execute only one among the plurality of processings, or may be configured to selectively use and execute the plurality of processings.

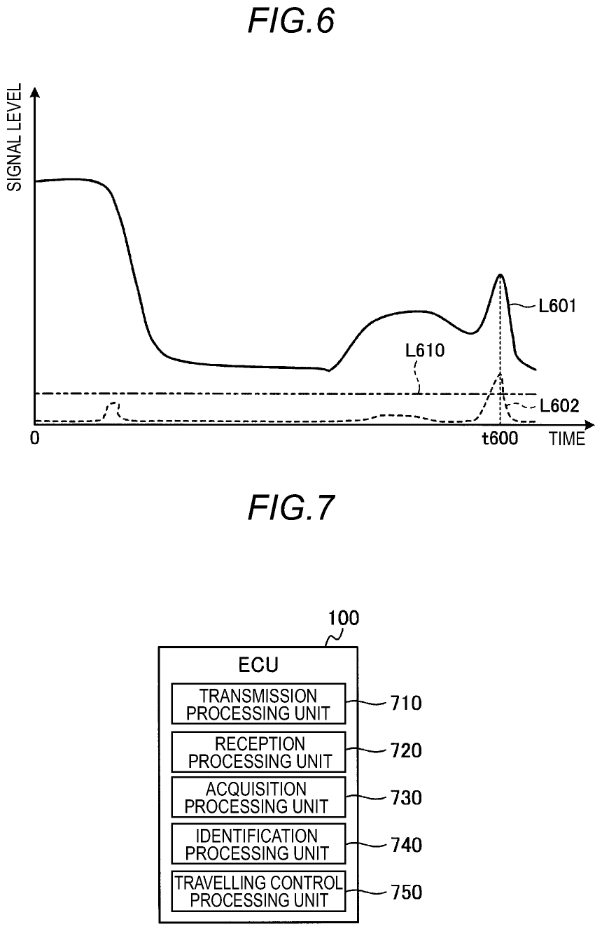

FIG. 6 is an exemplary and schematic diagram showing an example of waveforms of signals before and after the CFAR processing according to the embodiment.

In the example shown in FIG. 6, a waveform of a solid line L601 is a waveform representing a time change of the value (signal level) of the signal before the CFAR processing, that is, the processing target signal. A waveform of a broken line L602 is a waveform representing a time change of the value (signal level) of the signal after the CFAR processing, that is, the difference signal.

As shown in FIG. 6, the waveform of the solid line L601 and the waveform of the broken line L602 reach peaks at substantially the same timing t600. Therefore, when an appropriate threshold value such as a two-dot chain line L610 is set, if the timing t600 at which the waveform of the broken line L602 reaches the peak is detected by using the threshold value, the timing t600 at which the waveform of the solid line L601 reaches the peak can also be detected.

Referring back to FIG. 4, based on the above, the threshold value processing unit 427 compares the value (signal level) of the difference signal acquired by the CFAR processing unit 426 with a predetermined threshold value.

Then, the detection processing unit 428 detects, based on a processing result of the threshold value processing unit 427, a timing at which the value of the difference signal reaches a peak exceeding the predetermined threshold value.

Here, as described above, the timing at which the value of the difference signal reaches the peak substantially coincides with a timing at which the signal level of the reception wave which is the transmission wave returned due to reflection reaches the peak. Therefore, if an appropriate predetermined threshold value is set in the threshold value processing unit 427 such that the timing at which the value of the difference signal reaches the peak can be detected, the detection processing unit 428 can detect the distance to the object by the TOF method by specifying the timing at which the value of the difference signal reaches the peak exceeding the predetermined threshold value as the timing at which the signal level of the reception wave which is the transmission wave returned due to reflection reaches the peak exceeding the threshold value.

In the embodiment, the configurations shown in FIG. 4 can operate under control of the ECU 100 having a function shown in FIG. 7.

FIG. 7 is an exemplary and schematic block diagram showing the function of the ECU 100 according to the embodiment.

As shown in FIG. 7, the ECU 100 according to the embodiment includes a transmission processing unit 710, a reception processing unit 720, an acquisition processing unit 730, an identification processing unit 740, and a travelling control processing unit 750.

The transmission processing unit 710 controls the configuration on the transmission side of the distance detection device 200. For example, the transmission processing unit 710 controls the timing at which the pulse signal is generated by the code generation unit 412, the timing at which the carrier wave is output by the carrier wave output unit 413, and the like.

In addition, the reception processing unit 720 controls the configuration on the reception side of the distance detection device 200. For example, the reception processing unit 720 controls the timing at which the correlation value is started to be acquired by the correlation processing unit 424.

The acquisition processing unit 730 acquires, from the distance detection device 200, the distance to the object detected based on the difference signal after the CFAR processing and the value of the processing target signal at the detection timing at which the distance to the object is detected. Since the distance detection device 200 detects the distance to the object a plurality of times with a lapse of time, the acquisition processing unit 730 acquires a plurality of distances to the object and a plurality of values of the processing target signal, each corresponding to a plurality of detection timings.

Then, the identification processing unit 740 identifies the object based on data acquired by the acquisition processing unit 730. More specifically, the identification processing unit 740 identifies the object based on a transition, with the lapse of time, between the distance to the object and the value of the processing target signal at the detection timing at which the distance to the object is detected.

More specifically, the identification processing unit 740 identifies a height of an object in front of the vehicle 1 in the traveling direction based on the technical idea to be described below.

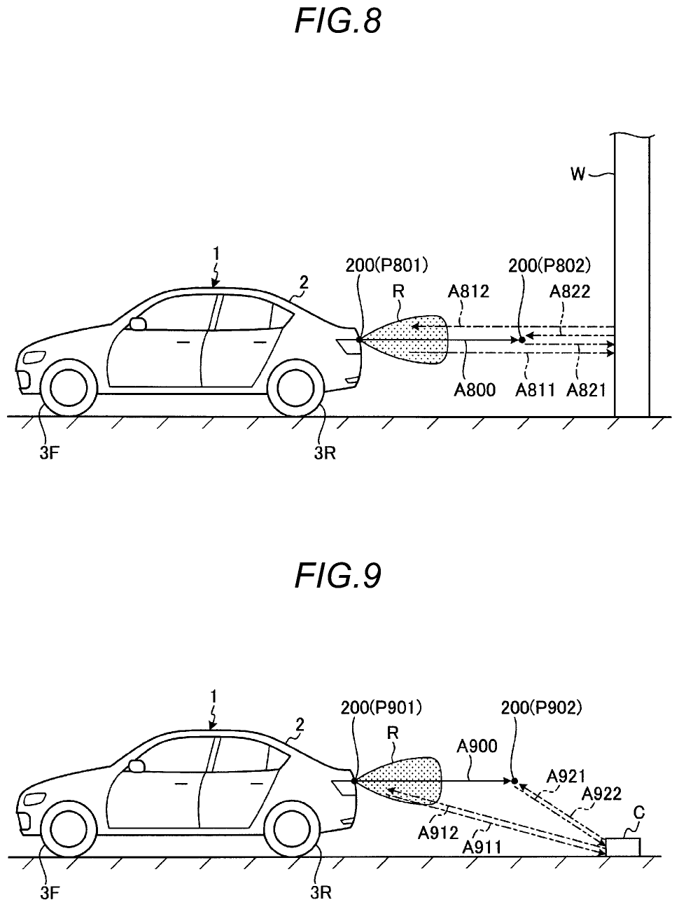

FIG. 8 is an exemplary and schematic diagram showing a situation in which a height of an object to be detected is high in the embodiment.

In an example shown in FIG. 8, the vehicle 1 is moved backward so as to approach a wall W as an object having a height equal to or higher than a predetermined height. At this time, the distance detection device 200 provided in the vehicle 1 is moved from a position P801 to a position P802 along an arrow A800.

In the example shown in FIG. 8, a hatched region R indicates a range of directivity of an ultrasonic wave transmitted by the distance detection device 200.

The distance detection device 200 at the position P801 transmits an ultrasonic wave in an arrow A811 direction, and receives the ultrasonic wave returned in an arrow A812 direction due to reflection by the wall W. In addition, the distance detection device 200 at the position P802 transmits an ultrasonic wave in an arrow A821 direction, and receives the ultrasonic wave returned in an arrow A822 direction due to reflection by the wall W.

As shown in FIG. 8, the arrow A811 and the arrow A821 coincide with each other as directions toward the wall W from a front, and the arrow A812 and the arrow A822 coincide with each other as directions opposite to the directions toward the wall W. Such a coincidence occurs when the object to be detected is an object such as the wall W having a height equal to or higher than an installation position of the distance detection device 200.

Here, intensity of the ultrasonic wave at a transmission time point at the position P801 and intensity of the ultrasonic wave at a transmission time point at the position P802 are the same. Therefore, when the intensity of the ultrasonic wave transmitted from the position P801 and returned to the position P801 is compared with the intensity of the ultrasonic wave transmitted from the position P802 and returned to the position P802, the latter, which has a shorter flight distance of the ultrasonic wave, is greater.

Based on the above, it can be said that when the object to be detected is an object such as the wall W having a height equal to or higher than the installation position of the distance detection device 200, the transition, with the lapse of time, between the distance to the object and the value of the processing target signal at the detection timing at which the distance to the object is detected shows a first tendency in which the value of the processing target signal increases as the distance to the object decreases to a certain extent or less with the lapse of time.

Therefore, in the embodiment, when the transition, with the lapse of time, between the distance to the object and the value of the processing target signal shows the first tendency, the identification processing unit 740 identifies the object to be detected as an object such as the wall W having a height equal to or higher than a predetermined height.

On the other hand, FIG. 9 is an exemplary and schematic diagram showing a situation in which a height of an object to be detected is low in the embodiment.

In an example shown in FIG. 9, the vehicle 1 is moved backward so as to approach a curbstone C as an object having a height lower than a predetermined height. At this time, the distance detection device 200 provided in the vehicle 1 is moved from a position P901 to a position P902 along an arrow A900.

In the example shown in FIG. 9, a hatched region R indicates the range of directivity of the ultrasonic wave transmitted by the distance detection device 200, similarly to the example shown in FIG. 8.

The distance detection device 200 at the position P901 transmits an ultrasonic wave in an arrow A911 direction, and receives the ultrasonic wave returned in an arrow A912 direction due to reflection by the curbstone C. The distance detection device 200 at the position P902 transmits an ultrasonic wave in an arrow A921 direction, and receives the ultrasonic wave returned in an arrow A922 direction due to reflection by the curbstone C.

Here, when intensity of the ultrasonic wave transmitted at the position P901 and returned to the position P901 is compared with intensity of the ultrasonic wave transmitted at the position P902 and returned to the position P902, the latter, which has a shorter flight distance of the ultrasonic wave, is greater.

However, the ultrasonic wave transmitted from the position P902 in the arrow A911 direction is out of the range of directivity of the ultrasonic wave as compared with the ultrasonic wave transmitted from the position P901 in the arrow A921 direction. Such a situation occurs when the object to be detected is an object such as the curbstone C having a height lower than the installation position of the distance detection device 200.

Therefore, it can be said that, in consideration of not only the flight distance of the ultrasonic wave but also the directivity, when the intensity of the ultrasonic wave transmitted from the position P901 and returned to the position P901 is compared with the intensity of the ultrasonic wave transmitted from the position P902 and returned to the position P902, the latter is smaller.

Based on the above, it can be said that, when the object to be detected is an object such as the curbstone C having a height lower than the installation position of the distance detection device 200, the transition, with the lapse of time, between the distance to the object and the value of the processing target signal at the detection timing at which the distance to the object is detected shows a second tendency in which the value of the processing target signal decreases as the distance to the object decreases to a certain extent or less with the lapse of time.

Therefore, in the embodiment, when the transition, with the lapse of time, between the distance to the object and the value of the processing target signal shows the second tendency, the identification processing unit 740 identifies the object to be detected as an object such as the curbstone C having a height lower than the predetermined height.

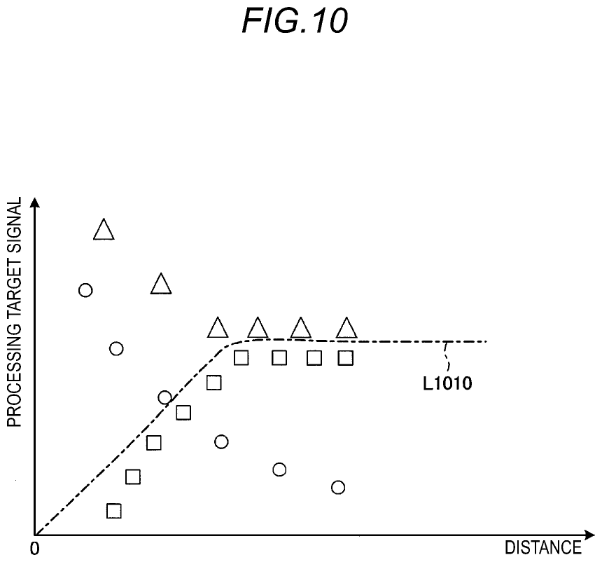

Here, a determination as to whether the transition, with the lapse of time, between the distance to the object and the value of the processing target signal shows the first tendency or the second tendency is executed based on the predetermined threshold value related to the correspondence relationship between the distance to the object and the value of the processing target signal as shown in FIG. 10.

FIG. 10 is an exemplary and schematic diagram showing an example of the threshold value to be used to identify an object according to the embodiment.

In an example shown in FIG. 10, a plurality of points plotted with Δ represent the transition, with the lapse of time, between the distance to the object and the value of the processing target signal when the object to be detected is the wall W. In addition, a plurality of points plotted by—represent the transition, with the lapse of time, between the distance to the object and the value of the processing target signal when the object to be detected is the curbstone C.

In the embodiment, the plurality of points plotted by Δ and the plurality of points plotted by □ can be distinguished from each other by a threshold value indicated by a one-dot chain line L1010 passing between the both. The one-dot chain line L1010 is determined in advance by an experiment or the like such that reflectance of the ultrasonic wave is established for any object.

In the example shown in FIG. 10, the threshold value indicated by the one-dot chain line L1010 includes a section in which the value of the processing target signal is constant regardless of the distance to the object. This is because, when the distance to the object increases to a certain extent or more, a mode of transmission and reception of an ultrasonic wave to and from the object, such as a direction of transmission and reception, can be considered to be substantially constant regardless of the height of the object to be detected. Actually, in the example shown in FIG. 10, the values of the processing target signal of the plurality of points plotted by Δ are substantially the same in a section in which the distance to the object is increased to a certain extent or more, and the values of the processing target signal of the plurality of points plotted by □ are also substantially the same in the section in which the distance to the object is increased to a certain extent or more.

Based on the above, in the embodiment, the identification processing unit 740 determines whether the transition shows the first tendency or the second tendency based on the comparison result between the transition, with the lapse of time, between the distance to the object and the value of the processing target signal, and the threshold value such as the one-dot chain line L1010.

For example, the identification processing unit 740 determines that the transition shows the first tendency when the value of the processing target signal with respect to the distance to the object transitions as a value exceeding the threshold value, and determines that the transition shows the second tendency when the value of the processing target signal with respect to the distance to the object transitions as a value smaller than the threshold value.

It is noted that, since the transmission and reception of an ultrasonic wave is likely to be affected by environment, it is desirable to perform the comparison using the threshold value a plurality of times in order to improve accuracy of the determination result. Therefore, in the embodiment, the identification processing unit 740 determines whether the transition shows the first tendency or the second tendency based on a plurality of comparison results between the threshold value and the transition, with the lapse of time, between the distance to the object and the value of the processing target signal.

In the example shown in FIG. 10, a plurality of points plotted by O represent the transition, with the lapse of time, between the distance to the object and the value of the processing target signal when the object to be detected is a person. In general, since a person has a height equal to or higher than the installation position of the distance detection device 200, the plurality of points plotted with O show the first tendency similarly to the plurality of points plotted with Δ.

However, since a surface of a person is generally soft, reflectance of the ultrasonic wave is smaller than that in the case of the wall W whose surface is generally hard. Therefore, as a whole, the plurality of points plotted with O have a smaller value of the processing target signal with respect to the distance to the object than the plurality of points plotted with Δ.

As described above, even when the tendency shown by the transition, with the lapse of time, between the distance to the object and the value of the processing target signal is the same, a specific mode of the transition varies depending on a type of the object.

Therefore, in the embodiment, if a map or the like indicating the correspondence relationship between the specific mode of the transition, with the lapse of time, between the distance to the object and the value of the processing target signal and the type of the object is set in advance, the identification processing unit 740 can identify not only the height of the object but also the type of the object.

Referring back to FIG. 7, the travelling control processing unit 750 controls the traveling state of the vehicle 1 according to the identification result of the identification processing unit 740. The travelling control processing unit 750 controls the traveling state of the vehicle 1 by controlling an acceleration system that controls an acceleration mechanism of the vehicle 1, a braking system that controls a braking mechanism of the vehicle 1, a steering system that controls a steering mechanism of the vehicle 1, a transmission system that controls a transmission mechanism of the vehicle 1, and the like.

For example, when the vehicle 1 is moved backward toward the wall W during parking or the like, it is necessary to stop the vehicle 1 before the rear end portion of the vehicle body 2 comes into contact with the wall W. Therefore, when it is confirmed that the wall W is present in the traveling direction of the vehicle 1 based on the identification result of the identification processing unit 740, the travelling control processing unit 750 controls a travelling control system of the vehicle 1 such that the vehicle 1 continues to be moved before the rear end portion of the vehicle body 2 comes into contact with the wall W.

On the other hand, when the vehicle 1 is moved backward toward the curbstone C, the vehicle 1 can be moved until the rear wheel 3R comes into contact with the curbstone C since the rear end portion of the vehicle body 2 does not come into contact with the curbstone C. Therefore, when it is confirmed that the curbstone C is present in the traveling direction of the vehicle 1 based on the identification result of the identification processing unit 740, the travelling control processing unit 750 controls the travel controlling system of the vehicle 1 such that the vehicle 1 continues to be moved until the rear wheel 3R of the vehicle body 2 rather than the rear end portion comes into contact with the curbstone C.

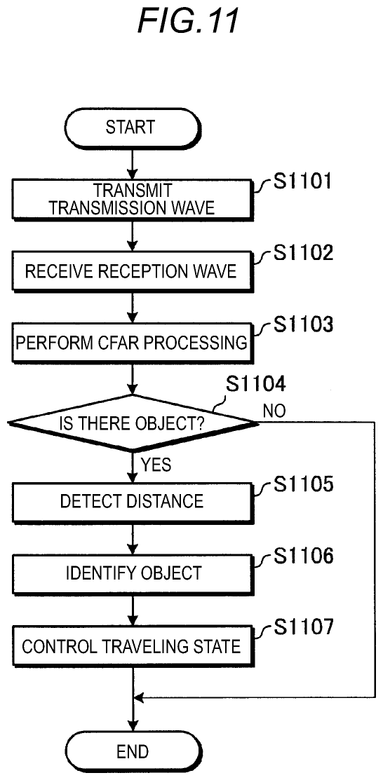

Based on the above configuration, the object detection system according to the embodiment performs a process as shown in FIG. 11 below. A series of processings shown in FIG. 11 may be repeatedly executed at a predetermined control cycle, for example.

FIG. 11 is an exemplary and schematic flowchart showing the process performed by the object detection system according to the embodiment.

As shown in FIG. 11, in the embodiment, first, in S1101, the wave transmitter 411 of the distance detection device 200 transmits a transmission wave, to which predetermined identification information is applied, under the control of the transmission processing unit 710 of the ECU 100, for example.

Then, in S1102, the wave receiver 421 of the distance detection device 200 receives a reception wave corresponding to the transmission wave transmitted in S1101. Then, the correlation processing unit 424 of the distance detection device 200 starts to acquire a correlation value corresponding to the degree of similarity of the identification information between the transmission wave and the reception wave under the control of the reception processing unit 720 of the ECU 100, for example.

Further, in S1103, the CFAR processing unit 426 of the distance detection device 200 performs the CFAR processing. The value of the difference signal acquired as a result of the CFAR processing is compared with a predetermined threshold value by the threshold value processing unit 427.

Then, in S1104, the detection processing unit 428 of the distance detection device 200 determines whether an object is detected, more specifically, whether the value of the difference signal acquired as the result of the CFAR processing reaches a peak exceeding the predetermined threshold value.

When it is determined in S1104 that no object is detected, the process ends. However, when it is determined in S1104 that an object has been detected, the process proceeds to S1105.

Then, in S1105, the detection processing unit 428 of the distance detection device 200 detects the distance to the object by the TOF method by specifying a timing at which the value of the difference signal reaches the peak exceeding the predetermined threshold value as a timing at which the signal level of the reception wave which is the transmission wave returned due to reflection reaches the peak.

The detection result of the distance to the object in S1105 is notified from the distance detection device 200 to the ECU 100 together with the value of the processing target signal before the CFAR processing. As described above, since the series of processes shown in FIG. 11 can be repeatedly executed in a predetermined control cycle, the correspondence relationship between the distance to the object and the value of the processing target signal can be notified from the distance detection device 200 to the ECU 100 a plurality of times.

Further, in S1106, the identification processing unit 740 of the ECU 100 identifies the object based on the transition between the distance to the object and the value of the processing target signal. An example of an object identification method has already been described, and thus description thereof will be omitted here.

Further, in S1107, the travelling control processing unit 750 of the ECU 100 controls the traveling state of the vehicle 1 based on the identification result in S1106. An example of a mode of controlling the traveling state of the vehicle 1 has already been described, and thus description thereof will be omitted here. Then, the process ends.

As described above, the object detection system according to the embodiment includes the wave transmitter 411, the wave receiver 421, the CFAR processing unit 426, the detection processing unit 428, and the identification processing unit 740. The wave transmitter 411 transmits a transmission wave. The wave receiver 421 receives a reception wave as the transmission wave reflected and returned by an object. The CFAR processing unit 426 samples the processing target signal corresponding to the reception wave, and acquires a difference signal based on a difference between a value of the processing target signal for at least one sample corresponding to the reception wave received at a certain detection timing and an average value of the values of the processing target signals for a plurality of samples corresponding to the reception wave received in at least one of a first period and a second period respectively existing before and after the detection timing and having a predetermined time length. The detection processing unit 428 detects, based on the value of the difference signal, the distance to the object at the detection timing a plurality of times with the lapse of time. The identification processing unit 740 identifies the object based on transition, with the lapse of time, between the distance to the object and the value of the processing target signal at the detection timing at which the distance to the object is detected.

According to the object detection system described above, the distance to the object can be detected based on the value of the difference signal, and the object can be identified based on a transition between the distance and the value of the processing target signal. Therefore, a detection result of the distance to the object and an identification result of the object can be obtained.

Here, in the embodiment, the identification processing unit 740 identifies the object depending on whether the transition between the distance to the object and the value of the processing target signal shows a first tendency in which the value of the processing target signal increases as the distance to the object decreases to a predetermined distance or less or shows a second tendency in which the value of the processing target signal decreases as the distance to the object decreases to the predetermined distance or less. According to such a configuration, the object can be accurately identified based on the tendency of the transition between the distance to the object and the value of the processing target signal.

More specifically, in the embodiment, the identification processing unit 740 determines whether the transition shows the first tendency or the second tendency based on a comparison result between the transition between the distance to the object and the value of the processing target signal and a predetermined threshold value related to a correspondence relationship between the distance to the object and the value of the processing target signal. According to such a configuration, identification of the object based on the tendency of the transition between the distance to the object and the value of the processing target signal can be easily performed by using the threshold value.

In the embodiment, the identification processing unit 740 determines whether the transition shows the first tendency or the second tendency based on a plurality of comparison results between the transition and the threshold value. According to such a configuration, for example, in comparison with a case where only one among the plurality of comparison results between the transition and the threshold value is considered, the object can be more accurately identified by considering the plurality of comparison results.

In the embodiment, the wave transmitter 411 and the wave receiver 421 are mounted on the vehicle 1. Then, the identification processing unit 740 identifies a height of the object in front of the vehicle 1 in a traveling direction thereof depending on whether the transition between the distance to the object and the value of the processing target signal shows the first tendency or the second tendency. According to such a configuration, the information related to traveling of the vehicle 1, such as whether the detected object is, for example, the wall W (see FIG. 8) or the curbstone C (see FIG. 9) can be easily identified.

The object detection system according to the embodiment also includes the travelling control processing unit 750 that controls the traveling state of the vehicle 1 according to the identification result of the identification processing unit 740. According to such a configuration, the traveling state of the vehicle 1 can be appropriately controlled by using the detection result of the distance to the object and the identification result of the object.

### Modification

In the embodiment described above, the technique of the present disclosure is applied to a configuration in which a distance to an object is detected by transmission and reception of an ultrasonic wave. However, the technique of the present disclosure can also be applied to a configuration in which a distance to an object is detected by transmission and reception of a wave other than an ultrasonic wave, such as a sound wave, a millimeter wave, a radar, and an electromagnetic wave.

In addition, in the above-described embodiment, a configuration in which the identification processing unit 740 as a function of identifying an object is provided in the ECU 100 is shown. However, in the technique of the present disclosure, the function of identifying an object may be provided in the distance detection device 200.

In addition, in the above-described embodiment, a configuration in which the identification processing unit 740 as the function of identifying an object and the travelling control processing unit 750 as a function of controlling the traveling state of the vehicle 1 are provided in the single ECU 100 is shown. However, the function of identifying an object and the function of controlling a traveling state of the vehicle 1 may be provided in separate ECUs.

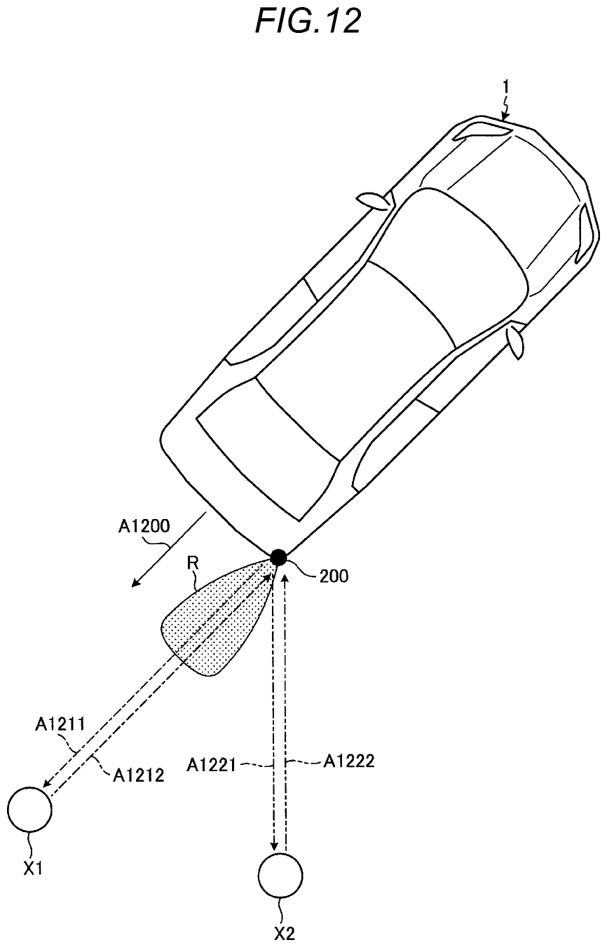

In addition, in the above-described embodiment, a configuration in which a height of an object is identified by the technique of the present disclosure in consideration of the transition, with a lapse of time, between the distance to the object and the value of the processing target signal is shown. However, as shown in FIG. 12, the technique of the present disclosure can also be used to identify a position of an object with respect to the traveling direction of the vehicle 1, more specifically, to identify whether the object is present in front of the vehicle 1 in the traveling direction.

FIG. 12 is an exemplary and schematic diagram for illustrating identification of an object according to a modification.

In an example shown in FIG. 12, the vehicle 1 is moved backward in an arrow A1200 direction so as to approach two objects X1 and X2. At this time, the distance detection device 200 provided in the vehicle 1 is also moved in the arrow A1200 direction. In the example shown in FIG. 12, a hatched region R indicates a range of directivity of an ultrasonic wave transmitted by the distance detection device 200.

The object X1 is present in front of the vehicle 1 in a traveling direction with respect to the distance detection device 200. Therefore, the object X1 reflects a transmission wave transmitted from the distance detection device 200 in an arrow A1211 direction that is the same as the arrow A1200 direction indicating the traveling direction of the vehicle 1. Then, the transmission wave reflected by the object X1 flies in an arrow A1212 direction opposite to the arrow A1211 direction, and is received as a reception wave by the distance detection device 200.

In addition, the object X2 is present at a position deviated from the front of the vehicle 1 in the traveling direction with respect to the distance detection device 200. Therefore, the object X2 reflects a transmission wave transmitted from the distance detection device 200 in an arrow A1221 direction different from the arrow A1200 direction indicating the traveling direction of the vehicle 1. Then, the transmission wave reflected by the object X2 flies in an arrow A1222 direction opposite to the arrow A1221 direction, and is received as a reception wave by the distance detection device 200.

Here, in the example shown in FIG. 12, the transmission and reception of an ultrasonic wave to and from the object X1 can be interpreted in the same manner as the transmission and reception of an ultrasonic wave to and from the wall W shown in FIG. 8. Therefore, in the example shown in FIG. 12, a transition, with the lapse of time, between a distance to the object X1 and a value of the processing target signal at a detection timing at which the distance to the object X1 is detected shows a first tendency in which the value of the processing target signal increases as the distance to the object X1 decreases to a certain extent or less with the lapse of time.

Therefore, in the modification, based on the fact that the transition, with the lapse of time, between the distance to the object and the value of the processing target signal shows the first tendency, the object to be detected can be identified as an obstacle having a high possibility of becoming an obstacle to the traveling of the vehicle 1, such as the object X1 present in front of the vehicle 1 in the traveling direction.

On the other hand, in the example shown in FIG. 12, the transmission and reception of an ultrasonic wave to and from the object X2 can be interpreted in the same manner as the transmission and reception of an ultrasonic wave to and from the curbstone C shown in FIG. 9. Therefore, in the example shown in FIG. 12, a transition, with the lapse of time, between a distance to the object X2 and a value of the processing target signal at a detection timing at which the distance to the object X2 is detected shows a second tendency in which the value of the processing target signal decreases as the distance to the object X2 decreases to a certain extent or less.

Therefore, in the modification, based on the fact that the transition, with the lapse of time, between the distance to the object and the value of the processing target signal shows the second tendency, the object to be detected can be identified as a non-obstacle having a low possibility of becoming an obstacle to the traveling of the vehicle 1, such as the object X2 present at a position deviated from the front of the vehicle 1 in the traveling direction.

As described above, the technique of the present disclosure is used not only for identification of a height of an object with respect to the vehicle 1 in the traveling direction but also for identification of the position of the object, so that information related to traveling of the vehicle 1, such as whether the detected object is present, for example, in front of the vehicle 1 in the traveling direction or at a position deviated from the vehicle 1 in the traveling direction can be easily identified.

An object detection system as an example of the present disclosure includes: a transmission unit configured to transmit a transmission wave; a reception unit configured to receive a reception wave which is the transmission wave reflected and returned by an object; a signal processing unit configured to sample a processing target signal corresponding to the reception wave and acquire a difference signal based on a difference between a value of the processing target signal for at least one sample corresponding to a reception wave received at a certain detection timing and an average value of values of the processing target signals for a plurality of samples corresponding to a reception wave received in at least one of a first period and a second period respectively existing before and after the detection timing and having a predetermined time length; a detection processing unit configured to detect, based on a value of the difference signal, a distance to the object at the detection timing a plurality of times with a lapse of time; and an identification processing unit configured to identify the object based on a transition, with the lapse of time, between the distance to the object and the value of the processing target signal at the detection timing at which the distance to the object is detected.

According to the object detection system described above, the distance to the object can be detected based on the value of the difference signal, and the object can be identified based on the transition between the distance and the value of the processing target signal. Therefore, a detection result of the distance to the object and an identification result of the object can be obtained.

In the object detection system described above, the identification processing unit may be configured to identify the object depending on whether the transition shows a first tendency in which the value of the processing target signal increases as the distance to the object decreases to a predetermined distance or less or shows a second tendency in which the value of the processing target signal decreases as the distance to the object decreases to the predetermined distance or less. According to such a configuration, the object can be accurately identified based on the tendency of the transition.

In the object detection system described above, the identification processing unit may be configured to determine whether the transition shows the first tendency or the second tendency based on a comparison result between the transition and a predetermined threshold value related to a correspondence relationship between the distance to the object and the value of the processing target signal. According to such a configuration, identification of the object based on the tendency of the transition can be easily performed by using the threshold value.

In the object detection system described above, the identification processing unit may be configured to determine whether the transition shows the first tendency or the second tendency based on a plurality of comparison results between the transition and the threshold value. According to such a configuration, for example, in comparison with a case where only one among the plurality of comparison results between the transition and the threshold value is considered, the object can be more accurately identified by considering the plurality of comparison results.

In the object detection system described above, the transmission unit and the reception unit may be mounted on a vehicle, and the identification processing unit may be configured to identify a height of the object in front of the vehicle in a traveling direction depending on whether the transition shows the first tendency or the second tendency. According to such a configuration, information related to traveling of the vehicle, such as whether the detected object is a wall or a curbstone can be easily identified.

In the object detection system described above, the transmission unit and the reception unit may be mounted on a vehicle, and the identification processing unit may be configured to identify a position of the object with respect to the vehicle in the traveling direction depending on whether the transition shows the first tendency or the second tendency. According to such a configuration, information related to traveling of the vehicle, such as whether the detected object is present in front of the vehicle in the traveling direction or is present at a position deviated from the vehicle in the traveling direction can be easily identified.

In addition, in the object detection system described above, the transmission unit and the reception unit may be mounted on a vehicle, and the object detection system may further include a travelling control processing unit configured to control a traveling state of the vehicle depending on an identification result of the identification processing unit. According to such a configuration, the traveling state of the vehicle can be appropriately controlled by using the detection result of the distance to an object and the identification result of the object.

Although the embodiment and modification disclosed here have been described, these embodiment and modification have been presented by way of example only, and are not intended to limit the scope of the disclosure. Indeed, the novel embodiment and modification described herein may be carried out in a variety of forms, and various omissions, substitutions and changes may be made without departing from the spirit of the disclosure. The above-described embodiment and modification are contained in the scope and gist of this disclosure, and are contained in the disclosure described in the claims and the equivalent scope thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An object detection system, comprising:
a transmission unit configured to transmit a transmission wave;
a reception unit configured to receive a reception wave which is the transmission wave reflected and returned by an object;
a signal processing unit configured to sample a processing target signal corresponding to the reception wave and acquire a difference signal based on a difference between a value of the processing target signal for at least one sample corresponding to a reception wave received at a certain detection timing and an average value of values of the processing target signals for a plurality of samples corresponding to a reception wave received in at least one of a first period and a second period respectively existing before and after the detection timing and having a predetermined time length;
a detection processing unit configured to detect, based on a value of the difference signal, a distance to the object at the detection timing a plurality of times with a lapse of time; and
an identification processing unit configured to identify the object based on a transition, with the lapse of time, between the distance to the object and the value of the processing target signal at the detection timing at which the distance to the object is detected.

2. The object detection system according to claim 1, wherein
the identification processing unit is configured to identify the object depending on whether the transition shows a first tendency in which the value of the processing target signal increases as the distance to the object decreases to a predetermined distance or less or shows a second tendency in which the value of the processing target signal decreases as the distance to the object decreases to the predetermined distance or less.

3. The object detection system according to claim 2, wherein
the identification processing unit is configured to determine whether the transition shows the first tendency or the second tendency based on a comparison result between the transition and a predetermined threshold value related to a correspondence relationship between the distance to the object and the value of the processing target signal.

4. The object detection system according to claim 3, wherein
the identification processing unit is configured to determine whether the transition shows the first tendency or the second tendency based on a plurality of comparison results between the transition and the threshold value.

5. The object detection system according to claim 2, wherein
the transmission unit and the reception unit are mounted on a vehicle, and
the identification processing unit is configured to identify a height of the object in front of the vehicle in a traveling direction depending on whether the transition shows the first tendency or the second tendency.

6. The object detection system according to claim 2, wherein
the transmission unit and the reception unit are mounted on a vehicle, and
the identification processing unit is configured to identify a position of the object with respect to the vehicle in the traveling direction depending on whether the transition shows the first tendency or the second tendency.

7. The object detection system according to claim 1, wherein
the transmission unit and the reception unit are mounted on a vehicle, and
the object detection system further comprising:
a travelling control processing unit configured to control a traveling state of the vehicle depending on an identification result of the identification processing unit.
